(19) United States
(12) Patent Application Publication
(10) Pub. No.: US 2007/0180871 A1
(43) Pub. Date: Aug. 9, 2007

(54) Storage lock

(76) Inventors: Chris Irgens, Elm Grove, WI (US); Ken Burmesch, Port Washington, WI (US); Frank Scott, Milwaukee, WI (US)

Correspondence Address: CALFEE, HALTER & GRISWOLD LLP, 1400 MCDONALD INVESTMENT CENTER, 800 SUPERIOR AVENUE, CLEVELAND, OH, 44114, US

(21) Appl. No.: 11/703,909

(22) Filed: Feb. 8, 2007

Related U.S. Application Data
(60) Provisional application No. 60/771,551, filed on Feb. 8, 2006.

(51) Int. Cl. E05B 67/36

(52) U.S. Cl. 70/34

(57) ABSTRACT

A lock includes a lock body and a separate removable shackle rotatably mounted within the lock body. The shackle may include a head portion at an end of a shackle stem. The shackle head may rotate with respect to the shackle stem.

### CROSS-REFERENCE TO RELATED APPLICATIONS

This non-provisional application claims the benefit of U.S. Provisional Patent Application No. 60/771,551, entitled “Storage Lock,” filed on Feb. 8, 2006, the entire disclosure of which is incorporated herein by reference, to the extent that it is not conflicting with this application.

### FIELD OF THE INVENTION

The present invention relates to a lock and to a lock for securing an enclosed storage area having a door assembly.

### BACKGROUND OF THE INVENTION

Storage enclosures are used to enclose, store and secure various types of materials. One exemplary type of enclosure is located at a commercial storage facility having many enclosures that are individually leased. These enclosures may have locking structure that includes a sliding hasp design, such as a hasp assembly on an overhead garage door that offers owner and renter access. Traditional padlocks having U-shaped shackles are difficult to install in this application because of the hasp structure. Other prior art solutions such as discuss locks are bulky, expensive and offer limited key access. Further, certain locks that are installed into the hasp can be susceptible to breaking or cutting because of exposed shackle length.

There remains a need in the art for a storage lock that is easier to install and remove by an authorized user, offers improved key access, and is less susceptible to breaking or cutting.

### SUMMARY OF THE INVENTION

In several illustrated embodiments of the present invention, a lock for securing a storage enclosure is disclosed. The lock includes a lock body and a removable shackle that includes a shackle head at a distal end of a shackle stem. The shackle stem is rotatable about the lock body when in an engaged position. The shackle head may also be rotatable with respect to the shackle stem. The shackle stem and/or shackle head include structure that improves the convenience and security features of the lock.

Further features and advantages of the invention will become apparent from the following detailed description made with reference to the accompanying drawings.

### BRIEF DESCRIPTION OF THE DRAWINGS

FIG. 1 is a perspective view of an embodiment of the present invention, showing a storage lock in a disengaged position;

FIG. 2 is a cross-sectional view of the storage lock of FIG. 1, showing the storage lock in an engaged position;

FIG. 3 is an exploded view of the storage lock of FIG. 1;

FIG. 4 is a side cross-sectional view of a sliding hasp, showing the hasp secured by the storage lock of FIG. 1;

FIG. 5 is a perspective view of another embodiment of the present invention, showing a storage lock in a disengaged position;

FIG. 6 is a perspective view of yet another embodiment of the present invention, showing a storage lock in an engaged position;

FIG. 7 is a perspective view of yet another embodiment of the present invention, showing a storage lock in an engaged position;

FIG. 8 is a perspective view of yet another embodiment of the present invention, showing a storage lock in an engaged position;

FIG. 9 is a perspective view of yet another embodiment of the present invention, showing a storage lock in an engaged position;

FIG. 10 is a perspective view of yet another embodiment of the present invention, showing a storage lock in an engaged position;

FIG. 11 is a perspective view of yet another embodiment of the present invention, showing a storage lock in an engaged position; and

FIG. 12 is a perspective view of yet another embodiment of the present invention, showing a storage lock in an engaged position.

### DETAILED DESCRIPTION OF THE INVENTION

This Detailed Description of the Invention merely describes embodiments of the invention and is not intended to limit the scope of the claims in any way. Indeed, the invention as described is broader than and unlimited by the preferred embodiments, and the terms used have their full ordinary meaning.

The present invention will be described with use on a storage enclosure having a door that includes a sliding hasp. It should be understood that this is for exemplary purposes only and the invention can be applied to a wide variety of applications.

The present invention offers a lock design with numerous beneficial features. The lock is designed for use in applications where lock installation is difficult, such as for example, storage enclosure doors with sliding hasps. The rotation of the shackle relative to the lock body allows the shackle and lock body to pivot in installation thereby creating an additional degree of freedom. In addition, the shackle may include a rotatable head to provide yet another degree of freedom. While installed, the structure offers improved access to the key slot for ease of unlocking.

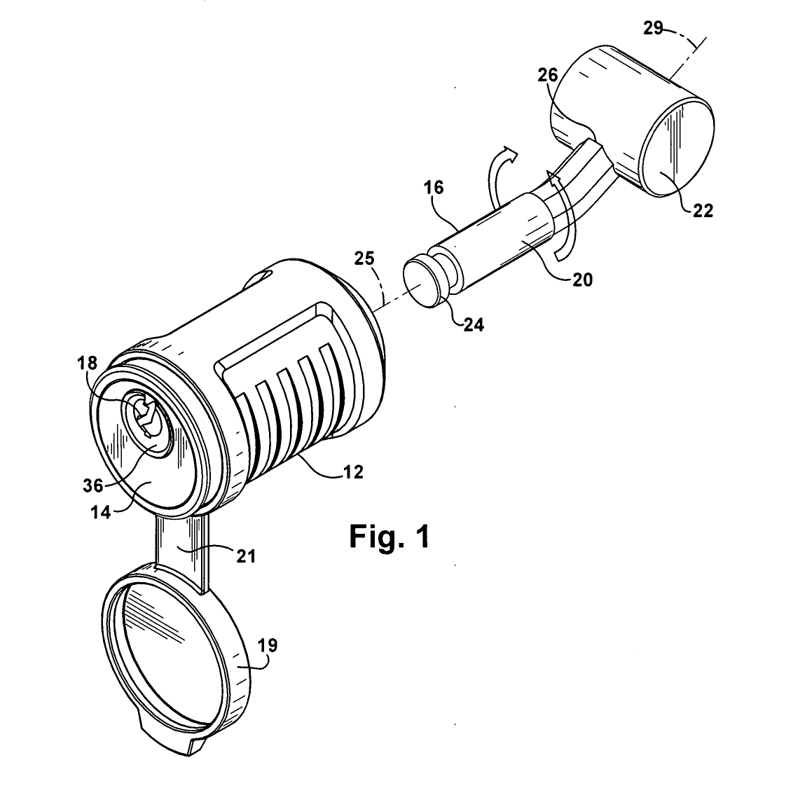

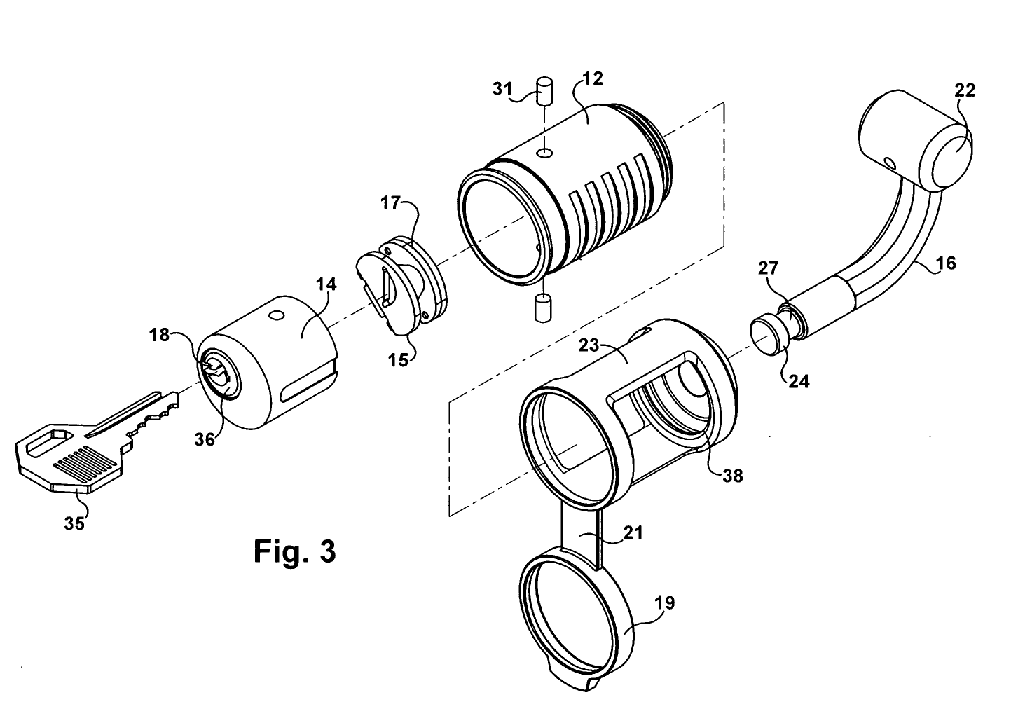

Referring now to the drawings, FIG. 1 is a perspective view of a storage lock 10 in a disengaged position. The lock 10 includes a lock body 12, a lock cylinder 14 contained within the lock body, and a removable shackle 16. A lock body boot 23 made of elastomeric material covers a portion of the lock body's outer surface to provide a compliant outer lock envelope that may reduce impact damage caused by the lock 10. The lock body boot 23 includes a lock cylinder cover 19 attached to the lock body boot 23 with a lock cylinder cover strap 21. The lock cylinder cover 19 protects the key slot 18 against becoming clogged with debris or corroded due to water or foreign body entry when the key slot is not in use. As will be described in more detail with reference to FIG. 3, the lock cylinder 14 is operated by insertion of a proper key 35 (see FIG. 3) into a key slot 18 to release the shackle 16 from a retaining plate 17 located in lock body 12. The retaining plate is configured to rotatably retain the shackle within the lock body 12 until it is released by operation of the lock cylinder 14.

The shackle 16 includes a shackle stem 20 and a shackle head 22. The shackle stem 20 includes a first end 24 for insertion into the lock body 12 and a second end 26. In the described embodiment, the first end includes a circular notch 27 a short distance from the first termination of the first end. As will be described in more detail with reference to FIG. 3, the circular nature of the notch 27 allows the shackle to be rotated 360 degrees within the lock body 12 about a shackle stem longitudinal axis 25. Rotation of the lock body with respect to the shackle stem allows the lock body to be moved to a position that provides more convenient access to the key slot 18. The shackle stem 20 shown in FIG. 1 is bent to increase the range of positions that the lock body 12 may be placed in by rotating the lock body relative to the shackle when the shackle head 22 is fixed in location.

The shackle head 22 may be fixed relative to the stem second end 26 by any suitable technique, such as for example, press fit, welded, or formed as a uniform piece. Alternatively, as shown in FIGS. 1-4, the shackle head 22 may be fixed to the shackle stem 20 in a manner that permits rotation of the shackle head 22 on the shackle stem 20 about a shackle head rotation axis 29. Rotation of the shackle head 22 with respect to the shackle stem 20 allows the lock body to be moved to a position that provides more convenient access to the key slot 18 when the shackle head is fixed in location. When, as shown in FIGS. 1-4, the shackle 16 is rotatable within the lock body 12 and the shackle head 22 is rotatable with respect to the shackle stem 20, the lock 10 can be manipulated to provide a wider range of relative positions between the lock body 12 and shackle head 22 to facilitate installation of the lock 10 and access to the key slot 18 once the lock is installed.

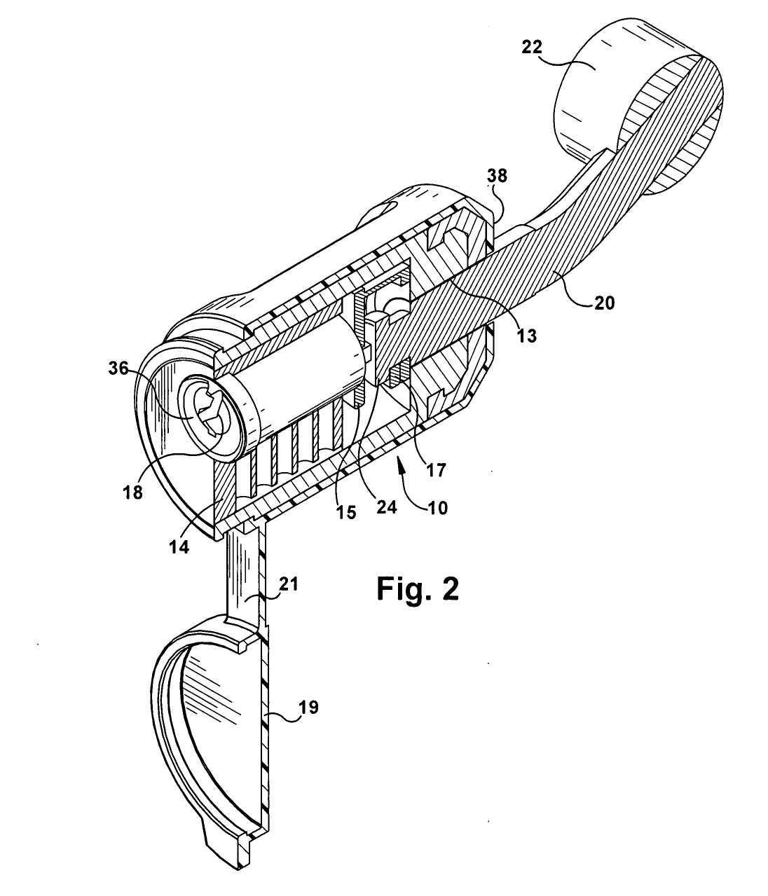

With reference to FIG. 2, which is a cross section view of the lock 10, and FIG. 3, which is an exploded view of the lock 10, the various components that make up the lock can be seen in greater detail. The lock body boot 23 includes an integrally molded lip seal 38 that presses into corresponding grooves in the lock body 12. The lip seal 38 seals the interface between an installed shackle 16 and a shackle exit hole 13 in the lock body 12. The lock body 12 houses the lock cylinder 14 and a lever and plate assembly that includes a release lever 15 and the shackle retaining plate 17. The shackle retaining plate 17 includes a slotted opening that can be moved by the release lever 15 into alignment with the shackle exit hole 13 to permit movement of the shackle 16 relative to the lock body. In its default position, the shackle retaining plate 17 is positioned so that the slotted opening is out of alignment with the exit hole 13 to prevent movement of the shackle relative to the lock body. The key slot 18 is located within a key cylinder 36 that rotates within the lock cylinder 14 when the proper key is inserted into the key slot. A key cylinder tab 35a engages the release lever 15 so that movement of the key cylinder causes the release lever to rotate the retaining plate 17 to the position in which the shackle can be inserted or removed from the lock body 14. When the key cylinder 36 is rotated back to its original position in which the key can be inserted or removed, the retaining plate 17 is placed in the position in which the shackle can neither be inserted nor removed from the lock body.

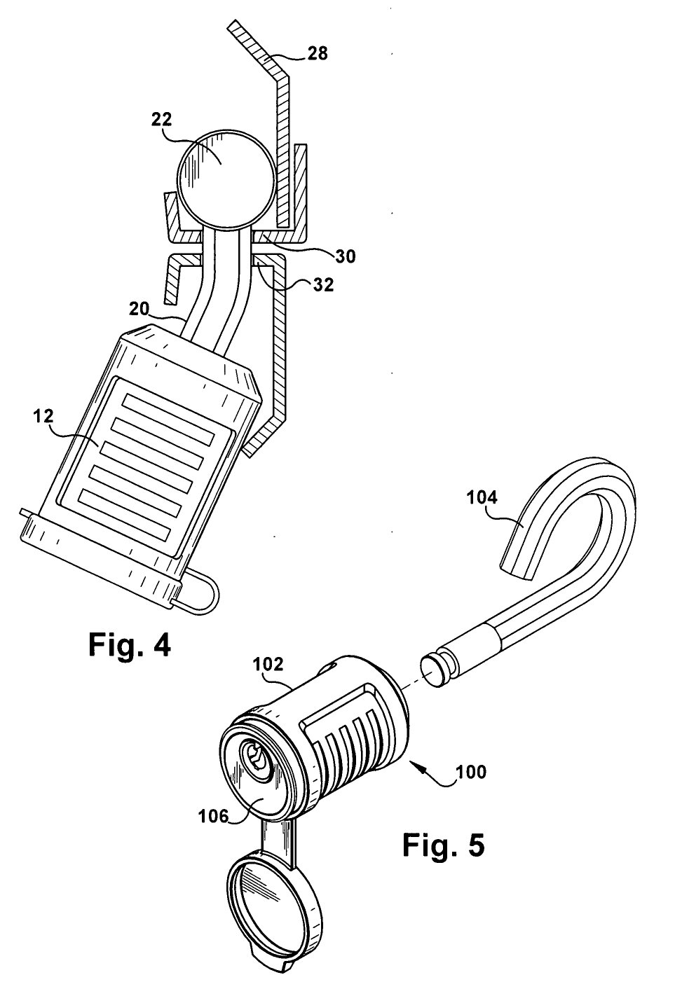

FIG. 4 is a side view of a sliding hasp assembly 28 shown in cross section as secured by the storage lock 10. In FIG. 4, the shackle 10 is shown protruding through two aligned holes in sliding hasp plates 30, 32. The shackle head 22 is nested between the two hasp plates 30, 32. The bent shackle stem 20 allows for the body 12 to have clearance from the hasp portion 32 to provide better access to the key slot as well as limit access to the shackle stem by a cutting device, such as for example, bolt cutters. Further, the lock 10 can pivot about the shackle head 22 to facilitate installation of the lock 10 to the hasp 28.

Other embodiments of the present invention in which the shackle head is fixed with respect to the shackle stem are shown in FIGS. 5-8. In FIG. 5, a lock 100 is shown that includes a lock body 102 and a J-shaped shackle 104. The shackle 104 is rotatable about an axis defined by a lock cylinder 106.

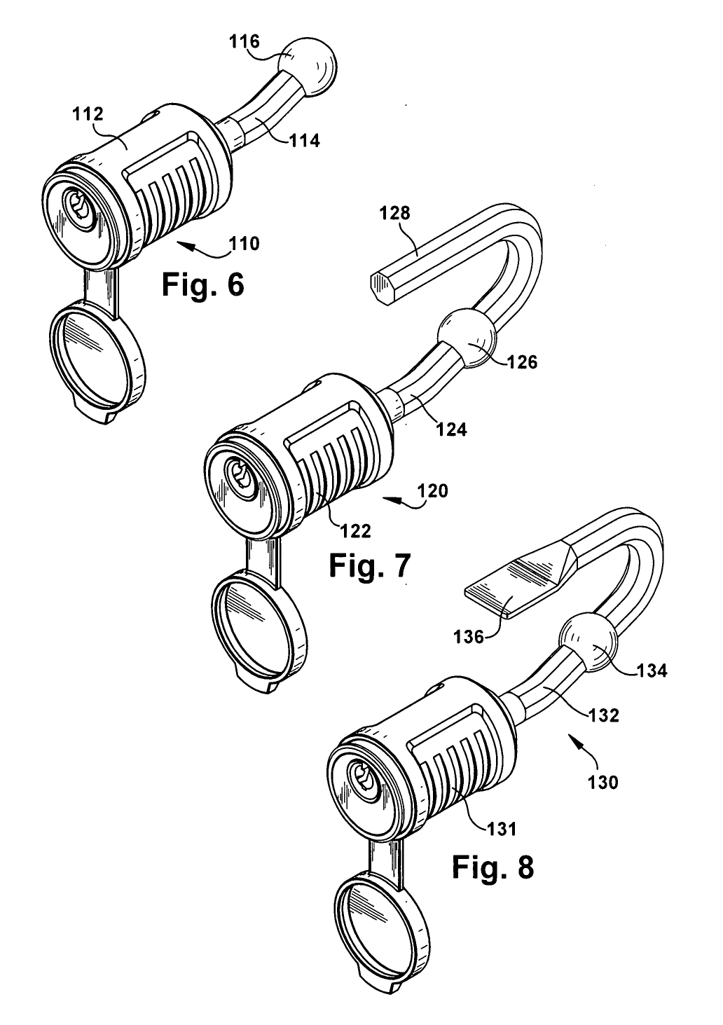

Another embodiment of the present invention is shown in FIG. 6. A lock 110 is shown that includes a lock body 112 and a shackle 114 including a spherical head 116. In an installed position, the lock 112 can be pivoted about the sphere 116. The shackle 114 is rotatable about an axis defined by a lock cylinder (not shown) within the lock body 112.

Another embodiment of the present invention is shown in FIG. 7. A lock 120 is shown that includes a lock body 122 and a J-shaped shackle 124. The shackle 124 includes a spherical head 116 at a position between the ends of the shackle stem. The shackle 124 is rotatable about an axis defined by a lock cylinder (not shown) within the lock body 122. FIG. 8 shows a similar embodiment. A lock 130 includes a J-shaped shackle 132. The shackle 132 includes a spherical head 134 at a position between the ends of the shackle stem. The distal end of the stem includes a flat area 136.

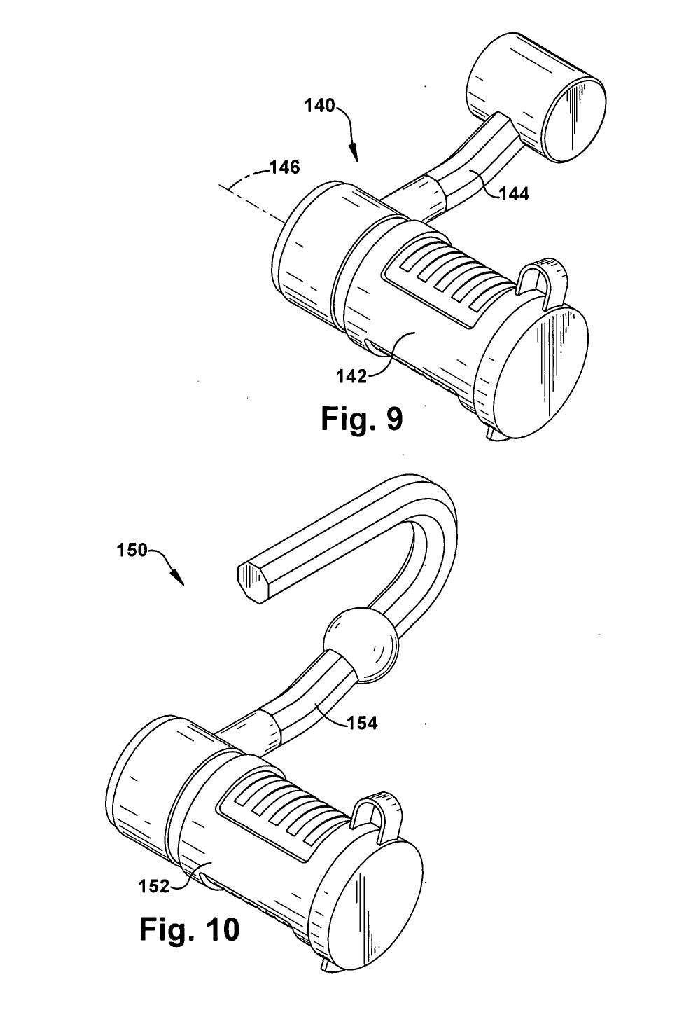

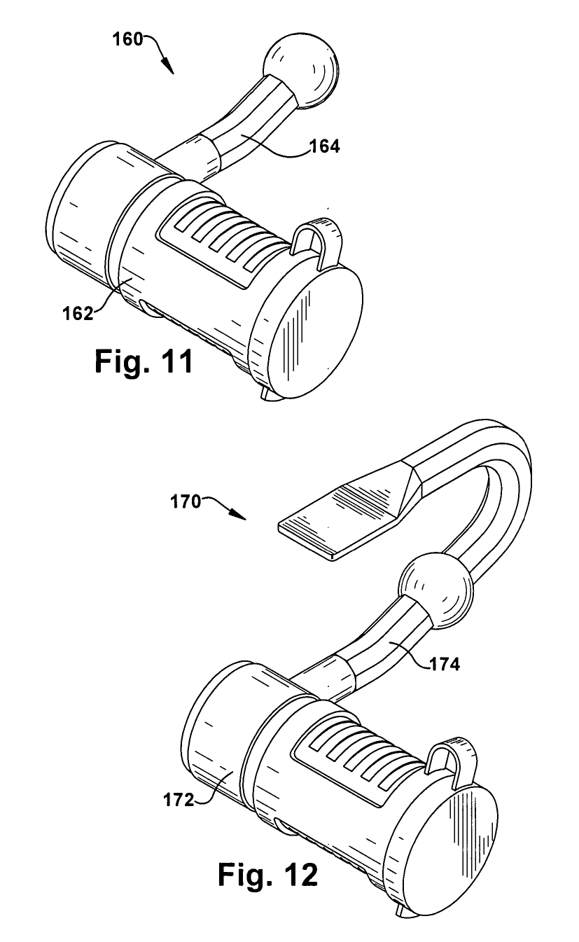

Additional embodiments of the present invention in which the shackle protrudes from the lock body at a right angle to a lock body axis 146 are disclosed in FIGS. 9-12. Each lock 140, 150, 160, 170 includes a shackle of a structure previously discussed. However, the shackle 144, 154, 164, 174 of each of these locks is rotatably engaged with a lock cylinder 142, 152, 162, 172 at a 90° angle with the longitudinal axis of the lock body (see axis 146 in FIG. 9). As such, each lock 140, 150, 160, 170 offers the same benefits as the previous locks discussed. For example, the lock cylinder 142 can be rotated upward in either direction for key slot access for a user.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

We claim:

1. A lock comprising:
a shackle comprising a shackle stem that includes a lock engagement feature at a first distal end;
a lock body that is separable from the shackle and comprises a locking mechanism coupled to a shackle retaining mechanism, the locking mechanism operative to place the shackle retaining mechanism in either a shackle hold position in which the shackle retaining mechanism retains the lock engagement feature to connect the shackle to the lock body or a shackle release position in which the shackle retaining mechanism does not retain the lock engagement feature to connect the shackle to the lock body; and
wherein the lock engagement feature is retained by the shackle retaining mechanism such that the shackle can be rotated with respect to the lock body about a shackle stem longitudinal axis.

2. The lock of claim 1 wherein the locking mechanism comprises a key cylinder having a key slot and wherein the key cylinder can be rotated within the lock body when a proper key is inserted into the key slot.

3. The lock of claim 1 wherein the lock body has a generally cylindrical shape having a lock body longitudinal axis that is generally parallel to the shackle stem longitudinal axis.

4. The lock of claim 1 wherein the lock body has a generally cylindrical shape having a lock body longitudinal axis that is generally perpendicular to the shackle stem longitudinal axis.

5. The lock of claim 1 wherein the shackle stem is bent to form a first stem portion disposed at an angle to a second stem portion, wherein the first stem portion includes a first shackle stem portion longitudinal axis that corresponds to the shackle stem shackle stem first axis and the second stem portion includes a second shackle stem portion longitudinal axis that intersects the first shackle stem longitudinal axis at a stem bend angle.

6. The lock of claim 1 wherein the shackle comprises a shackle head at a second distal end of the shackle stem.

7. The lock of claim 6 wherein the shackle head has a generally cylindrical head shape having a shackle head longitudinal axis that is generally perpendicular to the shackle stem longitudinal axis.

8. The lock of claim 6 wherein the shackle head is configured to rotate about the shackle stem longitudinal axis.

9. The lock of claim 6 wherein the shackle head has a generally spherical shape.

10. The lock of claim 6 wherein the shackle head is formed by bending the shackle stem to form the second distal end into a generally J shape.

11. The lock of claim 10 wherein the second distal end is tapered to a flat portion.

12. The lock of claim 6 wherein the shackle includes a rounded annular protrusion disposed between the first and second distal ends of the shackle stem.

13. The lock of claim 5 wherein the shackle comprises a shackle head at a second distal end of the shackle stem.

14. The lock of claim 13 wherein the shackle head rotates with respect to the second stem portion about the second shackle stem portion longitudinal axis.

15. The lock of claim 13 wherein the shackle head has a generally cylindrical head shape having a shackle head longitudinal axis that is generally perpendicular to the second shackle stem portion longitudinal axis.

16. The lock of claim 13 wherein the shackle head has a generally spherical shape.

17. The lock of claim 13 wherein the shackle head is formed by bending the shackle stem to form the second distal end into a generally J shape.

18. The lock of claim 17 wherein the second distal end is tapered to a flat portion.

19. The lock of claim 13 wherein the shackle includes a rounded annular protrusion disposed between the first and second distal ends of the shackle stem.

20. A method of securing two hasps to each other comprising:
providing a lock body and shackle that is completely separable from the lock body, the shackle having a shackle stem;
passing the shackle stem through openings in each hasp; and
rotatably securing the shackle to the lock body with a locking mechanism.

21. The method of claim 20 wherein the step of securing the shackle to the lock body is performed by turning a key cylinder to actuate the locking mechanism to rotatably secure the shackle to the lock mechanism.
